(19) United States
(12) Patent Application Publication
(10) Pub. No.: US 2023/0416009 A1
(43) Pub. Date: Dec. 28, 2023

(54) PREDICTIVE MAINTENANCE SYSTEM, METHODS, AND APPARATUS FOR USE WITH CONVEYOR BELTS

(71) Applicant: Pablo Gonzalez, Weston, FL (US)

(72) Inventor: Pablo Gonzalez, Weston, FL (US)

(21) Appl. No.: 17/847,092

(22) Filed: Jun. 22, 2022

(51) Int. Cl. B65G 43/02

(52) U.S. Cl. CPC B65G 43/02; B65G 2203/0291; B65G 2207/48; B65G 2203/042; B65G 2203/0275

(57) ABSTRACT

A predictive maintenance system for a conveyor belt system may include a predictive maintenance device, which may be in communication with a central station. The device may communicate with the central station via a wired or wireless communication system. The conveyor belt system includes a belt for transporting product or material, which exert force on the belt which may eventually lead to wear or catastrophic failure of the belt. A device driver in the device may receive data from sensors and use the data to provide predictive maintenance models and detect faults.

### TECHNICAL FIELD

The technical field of the disclosed embodiments relate to predictive maintenance systems, methods, and devices. More particularly, the disclosed embodiments relate to predictive maintenance and fault detection systems, methods, and devices for use with conveyor belts.

### BACKGROUND

Conveyor belts are used in many commercial applications to transport products and material. The conveyor belts may be relatively long and may represent a high cost component for an industrial material handling operation. The conveyor belts and their components are susceptible to wear and tear as well as damage from the material being transported.

The various conveyor belt components and states, for example, belt position, speed, load, tension, rolling resistance, temperature, and belt condition, may be inspected and monitored. Such inspection and monitoring of the conveyor belt operating conditions and states helps to detect conditions that may lead to belt damage and/or a catastrophic failure. While catastrophic failures may be avoided by inspection and maintenance, these operations may be tedious and potentially hazardous.

In addition, many inspection operations require the system to be shut down to be able to be accurately measured, and only vibration can be conducted on a moving belt. When a belt is moving the lead roller creates tension, but the rest of the belt generates slack as it follows. This may throw off the sensors and lead to inaccurate data.

In the event the conveyor belt suffers catastrophic damage or otherwise becomes inoperable, the costs of repairing the conveyor belt, cleaning up product or material dropped due to the failure, and the downtime associated with a repair and/or replacement of damaged components may be substantial. Furthermore, the high rate of product/material transfer of most conveyor belts means that any downtime of the system may translate into significant production losses.

Thus, it is desirable to detect and stop the conveyor belt operation as soon as possible after a catastrophic failure has occurred. Also desirable is the ability to predict catastrophic faults before they occur and set up a maintenance window when the system may be taken offline. This may avoid damage to product components of the conveyor system due to such a fault, as well as the associated downtime for repair.

### SUMMARY

In an embodiment, a predictive maintenance system for a conveyor belt system includes a predictive maintenance device in communication with a central station. The device may communicate with the central station via a wired or wireless communication system. The conveyor belt system includes a belt for transporting product or material. Over time, the force exerted by the product or material, on the belt may eventually lead to wear or catastrophic failure of the belt. A device driver in the device may receive data from sensors and use the data to provide predictive maintenance models and detect faults.

The device may include two top wheels fixed to a support bar, which is connected to a support plate fixed on a support structure in the conveyor belt system. A force wheel may be connected to a housing and positioned below the top wheels, and the belt fed between the top wheels and the force wheel. The force wheel may move vertically in response to force exerted by the belt. This vertical movement may be translated to a horizontal movement by a rocker arm and the force transferred to a force sensor, e.g., a load cell.

A speed sensor may estimate the speed of the belt by measuring the rotations per minute of the force wheel. Data from the force sensor and the speed sensor may be digitized, filtered, and stored. The data may be provided to a processor in the device driver, which uses the data to perform data analysis and processing operations and fault detection operations as well as calibration operations at the sensors. The processor may generate predictive maintenance data and fault detection data for transmission to the central station. The central station may provide this information to a user via a user interface.

The device may also include a light emitting diode (LED) array including a number of LEDs which can emit different colors to indicate a tension on the belt, or indicate a fault. The LED may be provided on the housing of the device or in a separate module.

### BRIEF DESCRIPTION OF THE DRAWINGS

FIG. 1 shows a predictive maintenance system for use with conveyor belts according to an embodiment.

FIG. 2. shows a conveyor belt system including a conveyor belt predictive maintenance device according to an embodiment.

FIG. 3 is a front view of a conveyor belt predictive maintenance device according to an embodiment.

FIG. 4A is a perspective view of a conveyor belt predictive maintenance device according to another embodiment.

FIG. 4B is a sectional side view of the device of FIG. 4A

FIG. 4C is a perspective view of a speed sensor and force wheel component of the device of FIG. 4A.

FIG. 4D is a perspective view of an LED indicator and driver housing unit for use with the device of FIG. 4A.

FIG. 4E is a bottom view of the housing unit shown in FIG. 4D.

FIG. 4F is a top view of the housing unit shown in FIG. 4D.

FIG. 5 shows the components of a device driver according to an embodiment.

FIGS. 6A & 6B are a flowchart showing calibration and predictive maintenance operations performed by the system according to an embodiment.

### DETAILED DESCRIPTION

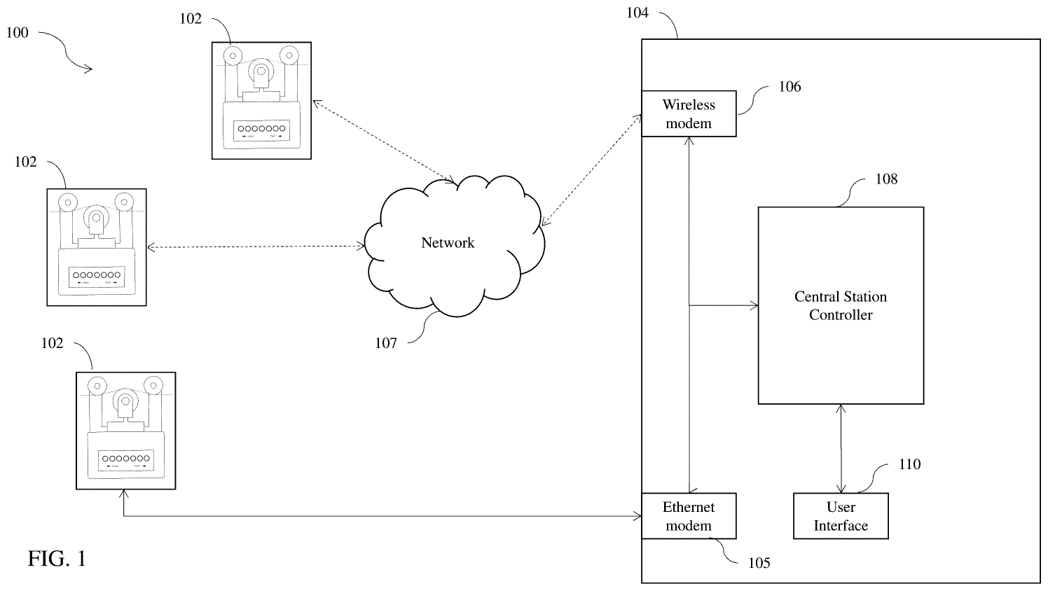

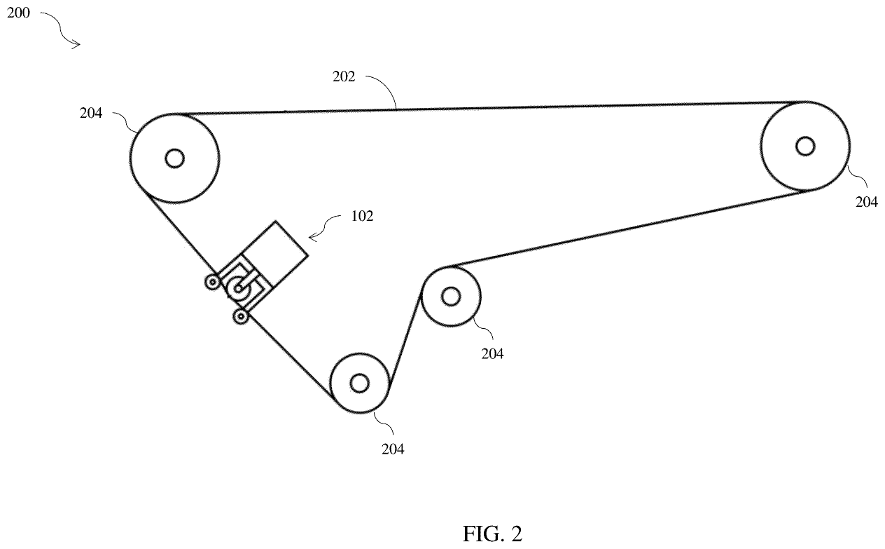

FIG. 1 shows a predictive maintenance system 100 for use with conveyor belts according to an embodiment. The system includes one or more conveyor belt predictive maintenance devices 102. The device 102 may be attached to a conveyor belt system 200, as shown in FIG. 2. The belt system 200 may include a belt 202, rollers 204, drive motors and other components (not shown).

Returning to FIG. 1, several devices 102 may each be connected to a different belt system, and all devices may communicate with a central station 104 through a wired communication system (e.g., via Ethernet modem 105) and/or a wireless communication system (e.g., via wireless modem 106 and wireless network 107). This information may be communicated to a central station controller 108. A user at the central station 104 may access information from the devices 102 via a user interface 110, allowing the user to monitor more than one device at the time.

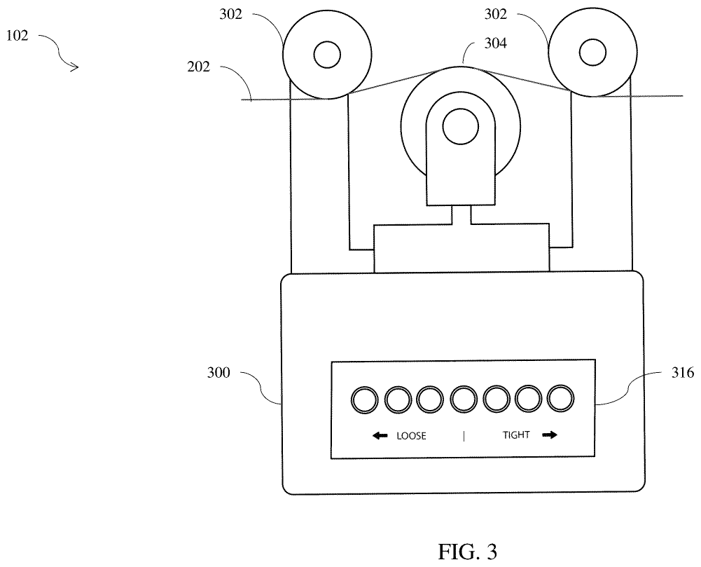

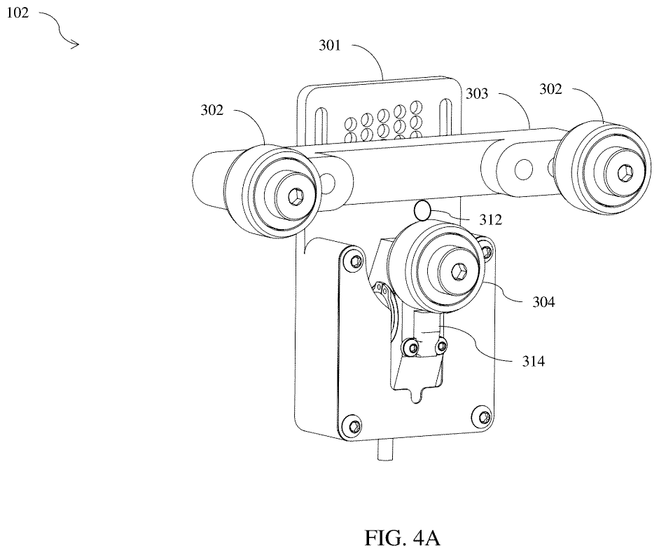

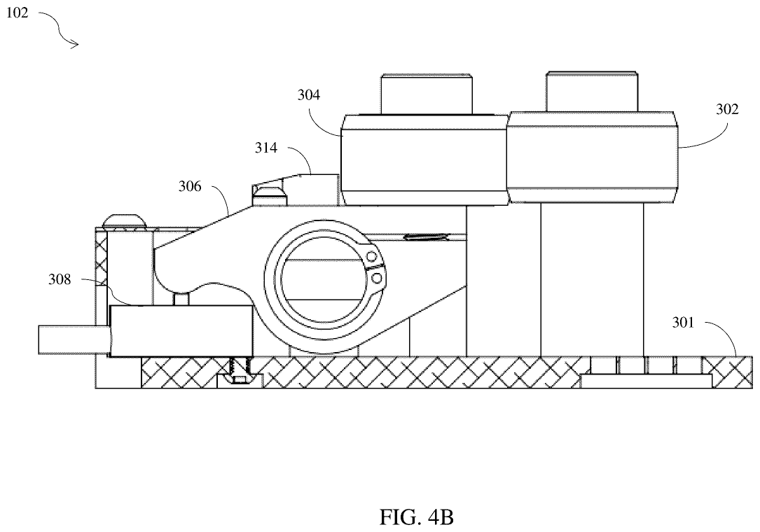

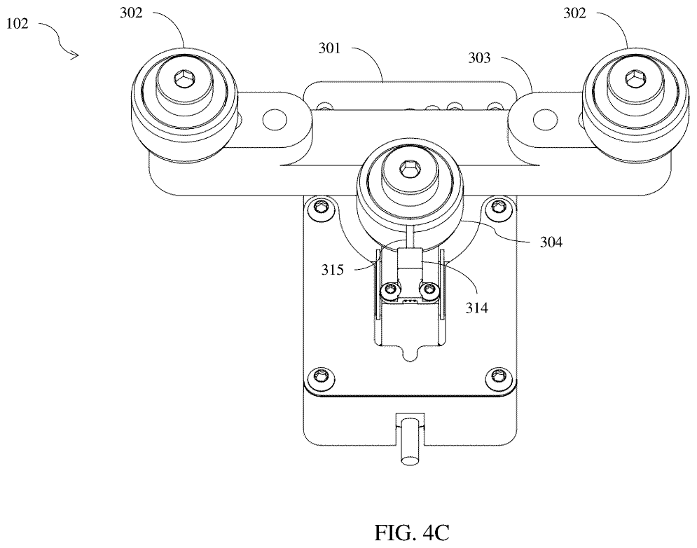

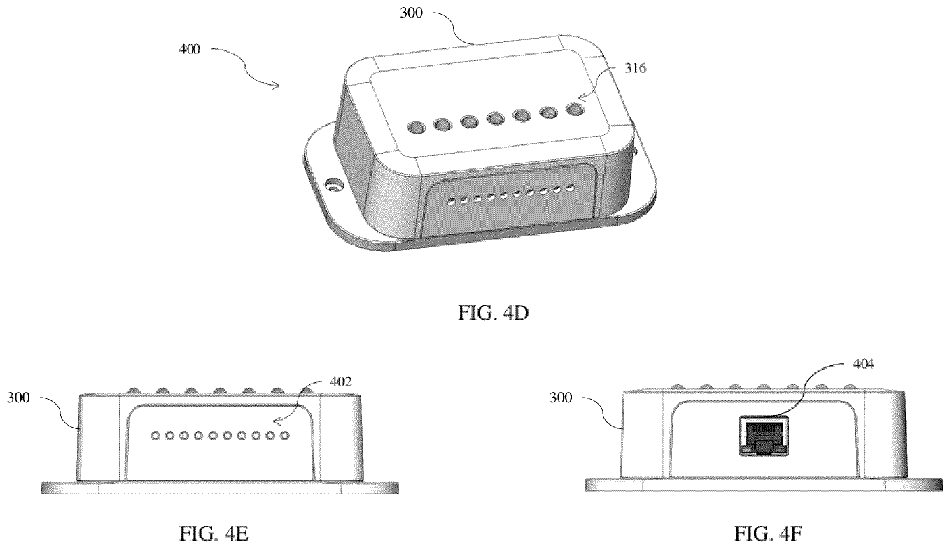

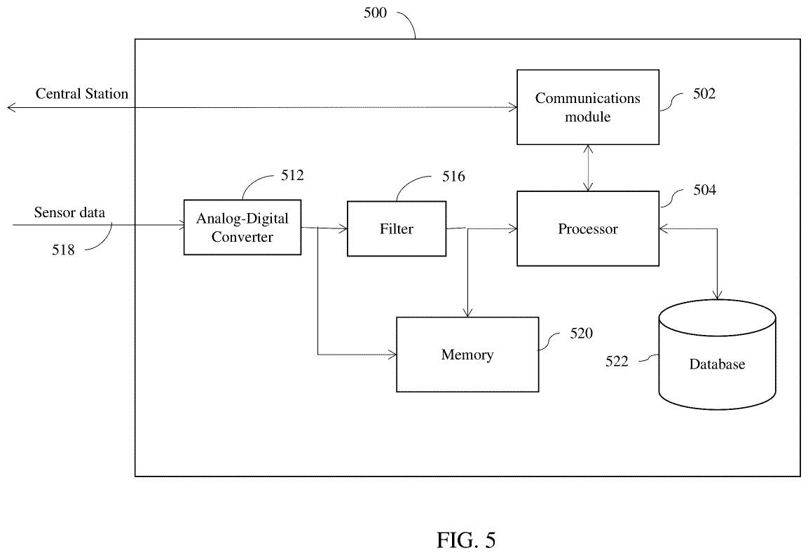

FIG. 3 shows a conveyor belt predictive maintenance device 102 according to an embodiment including a visual display, for example, an integrated LED indicator 316 (FIG. 3), and a driver 500 (FIG. 5), described below. FIGS. 4A-F show a device 102 according to another embodiment in which the LED indicator 316 and driver 500 are housed in a module 400 separate from the other components of the device, e.g., the wheels and sensors.

The device 102 may include a housing 300 to protect the electronic components of the device. The housing may be attached to a support plate 301, which may be mounted onto the frame of the conveyor belt system 200 at a desired location to provide a non-yielding structure. Two top load wheels 302 are attached to the top of the housing. The top load wheels 302 may be commercial-off-the-shelf (COTS) wheels made of stainless steel. In an embodiment, each wheel is about 1.25 inches in diameter, and 0.875 inch wide. Each top load wheel 302 may have a bearing in the center to allow for low friction rolling. The wheels may be attached to the housing by a shoulder screw with a shaft having a diameter that provides a press fit assembly, allowing the wheels to be easily removed and replaced for service. The top load wheels 302 may be fixed to the housing 300 and provide no vertical movement, only allowing for the belt 200 to pass through unobstructed.

In the embodiment shown in FIGS. 4A and 4B, the top load wheels 302 may be moved inwards to reduce or increase load based on belt thickness. The top load wheels may be connected to a support bar 303 which may be raised or lowered in increments to allow for various belt thickness.

Below the top load wheels 302 is a force wheel 304. The force wheel may be made of the same material and have the same dimensions as the top load wheels, as shown in FIGS. 4A-C, or another size, as shown in FIG. 3. The force wheel 304 may be attached to a rocker arm 306, which enables the force wheel 304 to move in a vertical direction to sense force.

As the belt 202 is tensioned, it will try to move into a straight line, thereby placing a load onto the force wheel 304 and pushing the force wheel 304 downwards. The force wheel allows for the belt 202 to pass through without causing degradation or damage to the belt. This allows for the belt system 200 to be operational while the system 100 is logging data.

The rocker arm 306 separates the rotating force wheel 304 from a load cell 308 to avoid damage from the rotating piece (force wheel) on a stationary part (load cell). The rocker arm also transfers the load from a downward (vertical) direction into a perpendicular (horizontal) one. This eliminates the need to have a wheel cradle that can move linearly yet still touch the load cell, which could require numerous parts to accomplish. Transferring the load 90 degrees also allows for force to be removed from the rocker arm and the mounting hardware. Instead, force is transferred directly to the load cell 306. This arrangement eliminates flexing and loss in the system and enables the device to detect force more easily.

The load cell 306 acts as a force sensor. Load cells come in a variety of load sizes, for example, 5 kg to 1000 kg. The smaller the size, the finer the resolution. The load size of the load cell may be selected based on the load being seen on the belt for the particular belt system, thereby providing a grade of resolution appropriate for the system. In an embodiment, the load cell 306 may be replaced without modifications to system using a screw-in mounting system, wherein the load cell screws from behind and connects directly to the driver 500.

The force sensor may be selected from various types of load/force sensor transducers in multiple arrangements. The force sensor material(s) may be selected from, for example, microelectromechanical systems (MEMS), strain gauge, and piezoelectric or vibrating load cells. The force sensor types may be, for example, single point, planar beam, S-Type, compression, or load-pins.

In addition to the force sensor, other sensors may be incorporated into the device 102. For example, a proximity sensor 312 may be installed on the support plate between the top load wheels 302 and force wheel 304. The proximity sensor measures how close the belt 202 edge is to the device housing and may be used to measure belt tracking. Belt tracking ensures the belt is running straight in the system and is not shifting to either side of the conveyor structure, which may create premature wear.

A speed sensor 314 may be attached to the force wheel 304 and provide data representative of belt speed, e.g., based on revolutions per minute (RPM). RPM measurement techniques, include, for example, rotary encoders, proximity sensors, photoelectric sensors, and optical sensors. In the embodiment shown in FIG. 4C, the force wheel 304 includes a notch 315, which may serve as a reference point to signal one revolution to the speed sensor. The data provided from the speed sensor may be used to detect slipping, turn-on and turn-off of the belt, and overall load, which may affect the speed.

The sensors may be connected in any series, parallel, or series-parallel combination to evenly distribute loads, or collect data points in different physical locations. In embodiment, backup systems may be built into each standalone sensor. The backup system may include, for example, a battery, super-capacitor, energy harvesting via transducers, etc., to provide a temporary power source and a memory to store calibration parameters for retrieval in the event of a power interrupt.

As shown in FIG. 3, the device 102 may include a visual display to indicate the tension of the belt on a spectrum from “loose” to “tight” based on a reading from the force sensor. The visual display may enable the user to determine if the belt is being over tightened or not. If the belt is overtightened, it may lead to premature bearing failure. If the belt is too loose, the belt may just slide around. Once the belt is running, the system can monitor belt stretch over time.

In an embodiment, the visual display may be a light emitting diode (LED) array 316 including a number of individual LEDs 318. Each LED 318 may be a dual color LED that emits either red or green visible light. The LEDs may emit red light or be OFF by default, with only one LED illuminated, e.g., emitting red or green. The illuminated LED indicates the belt tension, and as the belt is tightened or begins to stretch and loosen, the illuminated LED will shift position to another LED to indicate visually whether the belt is properly tensioned (center LED), too loose (LEDs to the left of center LED), or too tight (LEDs to the right of center LED). In other embodiments, the visual display may be, for example, a liquid crystal display (LCD).

The driver 500 may be situated in the bottom of the housing 300 (FIG. 3), or in a separate module 400, as shown in FIGS. 4D-F. The separate module may include the LED array 316 (FIG. 4D), input ports 402 for power, sensor connections 402 (FIG. 4E), and an Ethernet port 404 for wired communication (FIG. 4F).

The driver 500 may be a printed wiring assembly (PWA) and may contain all the logic required for the device 102. The driver may be powered from, for example, an electrical outlet or batteries.

The driver 500 may include a communication module 502 to communicate with the central station 104 (FIG. 1). The connection may be wired or wireless. A wired connection may be based on Ethernet technologies, e.g., CAT 5 or 6. The wireless communication technology for a particular application may be selected based on factors such as data transmission rate, distances involved, power consumption and availability, and equipment costs. Some wireless communication technologies include, for example, Bluetooth, LoRa, LTE, NB-IOT, WiFi, Z-Wave, Zigbee, or variants such as Bluetooth Low-Energy (BLE) or LoRaWAN. The wired/wireless communications may use encrypted protocols and unique identification numbers. The communication module 502 may be connected to a processor 504, which receives and processes the sensor data and communicates with the central station 104.

FIG. 5 shows components for collecting, filtering, and storing sensor data 518 at the device driver 500. The sensor data 518 may be collected via an analog-to-digital converter 512 situated between the processor 504 and the sensor, and according to different embodiments, may be stored at a memory device 520 at the sensor and/or the driver 500. Data may be retrieved using analog (voltage) or digital (I2C, SPI, UART, Serial) methods of communications between the sensor and processor 504.

Raw sensor data may be stored in a memory 520 for future processing, analysis, and retrieval. The memory 520 may include RAM for real time processing and/or ROM (EEPROM/FLASH) for storage. Data may be stored as fixed- or floating-point types.

Raw sensor data may be pre-filtered to remove data outliers and anomalies. Filter(s) 516 may include Low/High/Band Pass/Stop Filtering and complex filtering such as finite impulse response (FIR), infinite impulse response (IIR), Butterworth or multiple bi-quad filtering stages. Filters may be implemented in both the analog and digital domains. The filtered sensor data 518 may then be transmitted to the processor 504.

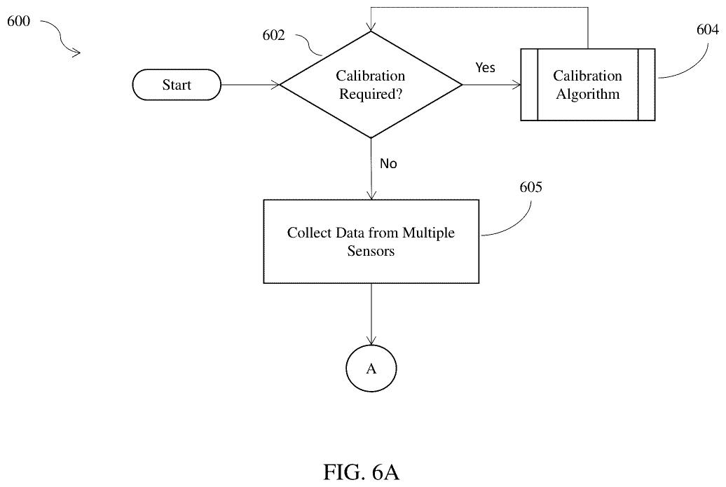

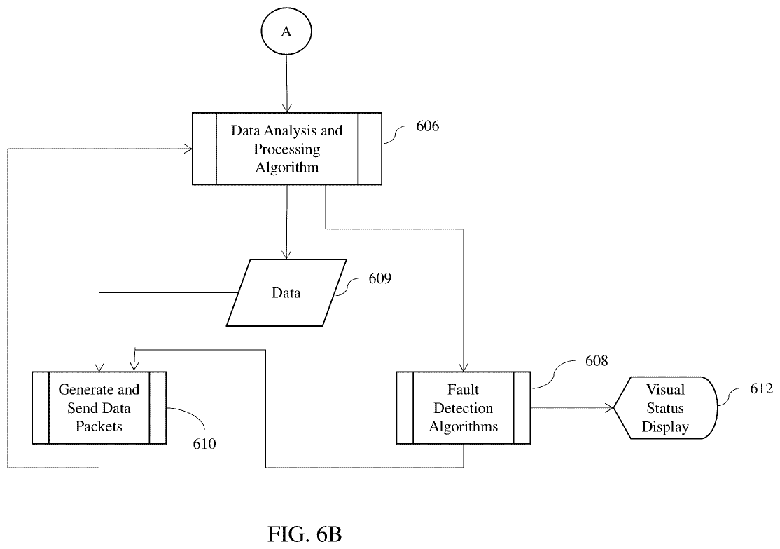

FIGS. 6A & 6B show an exemplary predictive maintenance operation 600 performed by the system according to an embodiment. The various algorithms and operations performed by the processor 504 may be stored as instructions in a memory 520 at the device driver 500. The instructions for the various algorithms and operations may be updated from the central station 104.

The central station controller 108 (FIG. 1) may include some or all of the components of the device driver 500. Accordingly, any operations described as being performed at the device driver 500 may also be performed at the central station 104. The processor 504 may determine whether a calibration operation is necessary (block 602). If so, the processor may perform a calibration algorithm (block 604) using data from the sensors, which may include the force sensor, speed sensor, and proximity sensor. Instantaneous calibration may be performed using multiple instantaneous sensor readings taken for calibration. Historical calibration may be based on trends generated using sensor data collected over a predetermined time, and may be stored in a database 522 at the device driver 500.

The calibration algorithm may be performed any time after the installation process, and may be triggered locally at the sensor, or in a remote location via a wired/wireless connection. The calibration algorithm may include factory calibration of sensor offsets for increased accuracy. The calibration algorithm may be site specific or non-site specific and may vary depending upon the final installation configuration.

After the device 102 has been calibrated, sensor data is collected (block 605) and used by the processor 504 to perform data analysis and processing algorithm(s) for data analysis and processing (block 606) and fault detection (block 608).

The data analysis and processing algorithm may generate data (block 609) to be used and stored by the device driver 500 and/or central station processor 108. The data may include filtered instantaneous and historical belt tension and belt speed. The historical data can vary from minutes to days in time for both tension and speed. Predictive fault data, which may include modeled predictions and raw trendline, and trendline analysis (slopes, y-intercepts) for all parameters (tension, speed). The modeled predictions may provide an anticipated failure time window so maintenance can be scheduled. The data may also include upper and lower failure thresholds which may be set based upon initial calibration, deviations from upper and lower thresholds (in % or other value), sensor time online, and data timestamps.

Predictive maintenance may be based on trend analysis. Sensor data may be collected over a period of time and stored in the database 522. The trend analysis may be based on statistical methods of creating trends that may include, for example, least-squares, linear regression or other methods that fit linear/non-linear data for analysis and post-processing. The data analysis and processing operation may process belt start-up or slowdowns and large and heavy loads as outliers of belt tension, allowing for a proper calculation of belt stretching, bearing wear-out or mechanical failure over time. The processor 504 may use this information to generate a time frame for when the belt is predicted to be stretched beyond its useful limit or bearings seizure and provide the user with a window of preventive maintenance. Data analysis and processing algorithms can be modified by OTA (Over the Air) updates to the embedded software in the memory 520.

Fault detection may be based on instantaneous analysis. Sensor data may be instantaneously analyzed to detect real-time faults, for example, belt jams, breaks, rips, etc., and provide a warning to the user. The analysis of the instantaneous data may include logical and peak/valley-value analysis algorithms that are compared to threshold values calculated during the calibration process or outside of a predetermined threshold.

The results of the data analysis and processing operation and fault detection operation may be transmitted to the central station as data packets (block 610) and the status displayed visually (block 612) at the user interface 110. In an embodiment, the LED array 316 may also blink all red in the event of a fault being detected.

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. A predictive maintenance device for a conveyor belt system including a belt, the device comprising:
a support plate;
a support bar connected to the support plate;
a plurality of top wheels fixed to the support bar;
a housing connected to the support plate;
a force wheel connected to the housing, wherein the plurality of top wheels and the force wheel provide a path for the belt, the force wheel operative to move vertically in response a force exerted by the belt;
a force sensor operative to measure force exerted by the belt and generate force sensor data;
a rocker arm connected between the force wheel and the force sensor, the rocker arm operative to translate vertical movement of the force wheel into a horizontal force onto the force sensor;
a speed sensor operative to estimate a speed of the belt and generate speed sensor data; and
a device driver comprising
a processor operative to receive force sensor data from the force sensor and speed sensor data from the speed sensor and generate predictive maintenance data from said data, and
a memory operative to store instructions for the processor and force sensor data and speed sensor data.

2. The device of claim 1, wherein the speed sensor is operative to measure rotations per minute (RPM) of the force wheel.

3. The device of claim 1, wherein the force sensor comprises a load cell.

4. The device of claim 1, wherein the processor is further operative to detect faults in the conveyor belt system and generate an alert.

5. The device of claim 1, further comprising a light emitting diode (LED) array including a plurality of LEDs and operative to provide a visual indication of the tension on the belt from the force sensor data.

6. The device of claim 5, wherein the LED array and the processor are housed in a module separate from the support plate and housing.

7. The device of claim 1, further comprising a communication module connected to the processor and operative to transmit and receive data.

8. The device of claim 7, wherein the communication module comprises a wireless modem.

9. The device of claim 7, wherein the communication module comprises a wired modem.

10. The device of claim 1, further comprising a proximity sensor operative to measure a distance of the edge of the belt to a known reference point to measure belt tracking, wherein the processor is further operative to receive and generate predictive maintenance data from the proximity sensor data.

11. A predictive maintenance system for a conveyor belt system including a belt, the system comprising:
device comprising
a support plate;
a support bar connected to the support plate;
a plurality of top wheels fixed to the support bar;
a housing connected to the support plate;
a force wheel connected to the housing, wherein the plurality of top wheels and the force wheel provide a path for the belt, the force wheel operative to move vertically in response a force exerted by the belt;
a force sensor operative to measure force exerted by the belt and generate force sensor data;
a rocker arm connected between the force wheel and the force sensor, the rocker arm operative to translate vertical movement of the force wheel into a horizontal force onto the force sensor;
a speed sensor operative to estimate a speed of the belt and generate speed sensor data;
a device driver comprising
a processor operative to receive force sensor data from the force sensor and speed sensor data from the speed sensor and generate predictive maintenance data from said data,
a communication module connected to the processor and operative to transmit and receive data, and
a memory operative to store instructions for the processor and force sensor data and speed sensor data; and
a central station comprising:
a controller,
a modem connected to the controller and operative to transmit and receive data to and from the device driver, and
a user interface connected to the controller operative to display information to and receive commands from a user.

12. The system of claim 11, wherein the modem comprises a wireless modem.

13. The system of claim 11, wherein the modem comprises a wired modem.

14. The system of claim 11, wherein the speed sensor is operative to measure rotations per minute (RPM) of the force wheel.

15. The system of claim 11 wherein the force sensor comprises a load cell.

16. The system of claim 11, wherein the processor is further operative to detect faults in the conveyor belt system and generate an alert.

17. The system of claim 11, wherein the device further comprises a light emitting diode (LED) array including a plurality of LEDs and operative to provide a visual indication of the tension on the belt from the force sensor data.

18. The system of claim 17, wherein the LED array and the processor are housed in a module separate from the support plate and housing.

19. The device of claim 1, further comprising a proximity sensor operative to measure a distance of the edge of the belt to a known reference point to measure belt tracking, wherein the processor is further operative to receive and generate predictive maintenance data from the proximity sensor data.
